(19) United States
(12) Patent Application Publication
(10) Pub. No.: US 2023/0085498 A1
(43) Pub. Date: Mar. 16, 2023

(54) THERMAL LINER

(71) Applicant: Fire-Dex, LLC, Medina, OH (US)

(72) Inventor: Matthew L. Colatruglio, Medina, OH (US)

(21) Appl. No.: 17/929,205

(22) Filed: Sep. 1, 2022

Related U.S. Application Data
(60) Provisional application No. 63/239,447, filed on Sep. 1, 2021.

(51) Int. Cl. A41D 31/06; A41D 13/002

(52) U.S. Cl. CPC A41D 31/065; A41D 13/002

(57) ABSTRACT

A protective garment comprises a thermal liner, a moisture barrier, and an outer shell. The thermal liner includes one or more augmented portions located at predetermined areas to enhance thermal properties of the thermal liner, and thereby the protective garment. In some embodiments, the augmented portions of the thermal liner each comprise an enhanced thermal layer and at least one of a facecloth layer and a first insulation layer.

### CROSS-REFERENCE TO RELATED APPLICATION

This application claims the benefit of U.S. Provisional Patent Application Ser. No. 63/239,447, filed Sep. 1, 2021, the entirety of which is herein incorporated by reference.

### FIELD

The present disclosure relates to protective garments and, more specifically, to a protective garment having a thermal liner that maximizes thermal protection while providing comfort to a wearer.

### BACKGROUND

Conventional firefighting turnout gear includes coats, pants, coveralls, helmets, gloves, footwear, and interface components. Typically, the coats and pants each comprises an outer shell, a moisture barrier located within the outer shell, a thermal liner located within the moisture barrier. The outer shell typically is constructed of an abrasion-, flame- and heat-resistant material such as a woven aramid material, typically NOMEX® or KEVLAR®, (all are trademarks of E. I. DuPont de Nemours & Co., Inc.) or a polybenzamidazole, a polybenzoxazole, or an oxidized polyacrylonitrile (OPAN) fiber material. The moisture barrier typically includes a semipermeable membrane layer which is moisture vapor permeable but impermeable to liquid moisture, such as CROSSTECH® (a trademark of W. L. Gore & Associates, Inc.) or STEDAIR® 4000 (a trademark of Stedfast Inc.). The membrane layer is bonded to a substrate of flame- and heat-resistant material, such as an aramid or PBI® material. Further, the thermal liner typically is constructed of a nonwoven fabric, usually spunlace, quilted to a facecloth layer.

One of the most dangerous threats to firefighters is heat exhaustion, which could possibly result in death. Creating a more comfortable protective garment is key to protecting firefighters from becoming overheated. In areas such as the shoulder and upper back yoke, protective garment manufacturers typically add multiple layers of fabric or pads to add protection, which includes the need to pass the conductive and compressive heat resistance test as specified in National Fire Protection Association (NFPA) 1971 standards, incorporated herein by reference. Adding multiple layers and/or pads adversely affects overall comfort of the protective garment due to its insulative nature and will increase the likelihood of heat exhaustion of the wearer.

Accordingly, it would be desirable to develop a protective garment having a thermal liner that maximizes thermal protection while providing comfort to a wearer.

### SUMMARY

In concordance and agreement with the presently described subject matter, a protective garment having a thermal liner that maximizes thermal protection while providing comfort to a wearer, has surprisingly been discovered.

In one embodiment, a portion of a thermal liner, comprises: a facecloth layer; and a thermal layer disposed adjacent the facecloth layer, wherein the thermal layer is produced from a fleece material.

As aspects of some embodiments, the facecloth is produced from at least one of an aramid, a polybenzimidazole, a polybenzoxazole, a melamine, a cellulosic, a flame resistant (FR) cellulosic, a modacrylic, and a carbon material.

As aspects of some embodiments, the portion of the thermal liner further comprises a first insulation layer disposed between the facecloth layer and the thermal layer.

As aspects of some embodiments, the first insulation layer is produced from at least one of a spunlace, a woven material, a nonwoven material, a stretch woven material, a knit material, a fleece material, and a laminate material.

As aspects of some embodiments, the fleece material is a blend of at least two different fibers.

As aspects of some embodiments, the fleece material comprises a blend of at least one of a meta-aramid material, a para-aramid material, and an anti-static material.

In another embodiment, a protective garment, comprises: an outer shell; and a thermal liner disposed adjacent the outer shell, wherein the thermal liner includes at least one augmented portion, the at least one augmented portion comprises a thermal layer produced from a fleece material.

As aspects of some embodiments, the at least one augmented portion of the thermal liner is positioned at least one of an elbow area, a back of a sleeve area, a knee area, an upper back area, and a shoulder area of the protective garment.

As aspects of some embodiments, the fleece material is produced from at least one of a meta-aramid material, a para-aramid material, and anti-static material.

As aspects of some embodiments, the outer shell is produced from at least one of an aramid material, a polybenzamidazole material, a polybenzoxazole material, and an oxidized polyacrylonitrile (OPAN) material.

As aspects of some embodiments, the augmented portion of the thermal liner further comprises at least one of a facecloth layer and a first insulation layer.

As aspects of some embodiments, the facecloth is produced from at least one of an aramid, a polybenzimidazole, a polybenzoxazole, a melamine, a cellulosic, a flame resistant (FR) cellulosic, a modacrylic, and a carbon material.

As aspects of some embodiments, the first insulation layer is produced from at least one of a spunlace, a woven material, a nonwoven material, a stretch woven material, a knit material, a fleece material, and a laminate material.

As aspects of some embodiments, a remainder portion of the thermal liner comprises at least one of a facecloth layer, a first insulation layer, and a second insulation layer.

As aspects of some embodiments, at least one of the first insulation layer and the second insulation layer is produced from at least one of a spunlace, a woven material, a nonwoven material, a stretch woven material, a knit material, a fleece material, and a laminate material.

As aspects of some embodiments, the outer shell is an exterior portion of a firefighter turnout gear.

In yet another embodiment, a method of producing a thermal liner, comprises the steps of: providing a facecloth layer, a first insulation layer, a thermal layer, and a second insulation layer; arranging the thermal layer together with at least one of the facecloth layer and the first insulation layer to form at least one augmented portion of the thermal liner; and arranging at least one of the facecloth layer, the first insulation layer, and the second insulation layer together to form a remainder portion of the thermal liner.

As aspects of some embodiments, the thermal layer is produced from a fleece material.

As aspects of some embodiments, the at least one augmented portion of the thermal liner is positioned at least one of an elbow area, a back of a sleeve area, a knee area, an upper back area, and a shoulder area of a protective garment.

As aspects of some embodiments, the thermal liner is configured for a protective garment.

### BRIEF DESCRIPTION OF THE DRAWINGS

The above, as well as other advantages of the present disclosure, will become readily apparent to those skilled in the art from the following detailed description of a preferred embodiment when considered in the light of the accompanying drawings.

FIG. 1 is a front elevational view of a protective garment according to an embodiment of the present disclosure, wherein a cutaway shows a thermal liner, a moisture barrier, and an outer shell;

FIG. 2 is a rear view of a thermal liner for a protective garment including a plurality of augmented portions according to an embodiment of the present disclosure;

FIG. 3 is an enlarged view of one of the augmented portions of FIG. 2;

FIG. 4 is a cross-sectional view of one of the augmented portions taken along section A-A of FIG. 3; and

FIG. 5 is a cross-sectional view of a remainder portion of the thermal liner of FIG. 2.

### DETAILED DESCRIPTION

The following detailed description and appended drawings describe and illustrate various exemplary embodiments of the present disclosure. The description and drawings serve to enable one skilled in the art to make and use the present disclosure, and are not intended to limit the scope of the present disclosure in any manner. In respect of the methods disclosed, the steps presented are exemplary in nature, and thus, the order of the steps is not necessary or critical.

The present disclosure describes a thermal liner, certified to the National Fire Protection Association (NFPA) 1971 standards having enhanced thermal properties such as enhanced thermal protection performance and total heat loss. Conventional firefighter turnout gear requires five or more layers to be compliant with the NFPA 1971 standards. For example, the conventional firefighter turnout gear includes an outer shell, a first moisture barrier, a first thermal liner, a second moisture barrier, and a second thermal liner. The present disclosure utilizes an enhanced thermal liner to reduce an amount of layers required for the protective garments, and more particularly to be compliant with the NFPA 1971 standards.

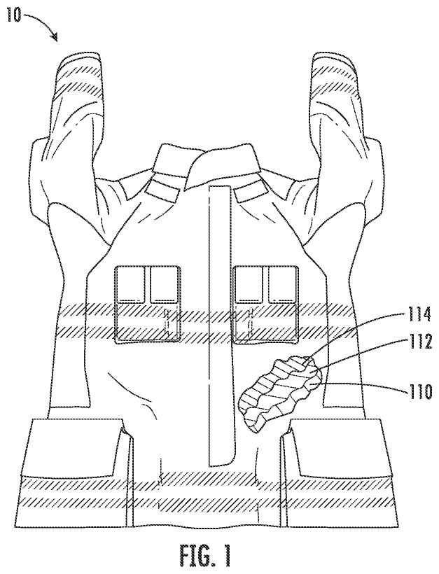

FIG. 1 illustrates an exemplary protective garment 10 which comprises a thermal liner 110 that forms an interior surface (i.e., a surface that contacts the wearer) of the protective garment 10, a moisture barrier 112 (i.e., an intermediate layer of the protective garment), and an outer shell 114 (i.e., an exterior of the protective garment). The moisture barrier 112 may be constructed of a non-woven or woven flame resistant fabric comprising flame resistant fibers made of, for example, at least one of an aramid (meta-and/or para-aramid), a polybenzimidazole, a polybenzoxazole, a melamine, or the like, and blends thereof. The moisture barrier typically includes a semipermeable membrane layer which is moisture vapor permeable but impermeable to liquid moisture, such as CROSSTECH® (a trademark of W. L. Gore & Associates, Inc.) or STEDAIR® 4000 (a trademark of Stedfast Inc.). The membrane layer is bonded to a substrate of flame- and heat-resistant material, such as an aramid or PBI® material. The moisture barrier 112 may be laminated with a water-impermeable layer of material (not depicted) such as, for instance, a layer of polytetrafluoroethylene (PTFE), expanded polytetrafluoroethylene (ePTFE), or polyurethane (PU). When such an impermeable layer is provided, it usually is provided on the moisture barrier, so as to face the thermal liner 110. It is understood that the moisture barrier 112 may have any suitable thickness as desired.

The outer shell 114 is typically constructed of a heat and flame resistant material that comprises flame resistant fibers made of, for example, at least one of an aramid (meta- and/or para-aramid), a polybenzamidazole, a polybenzoxazole, an oxidized polyacrylonitrile (OPAN), or the like, and blends thereof. The outer shell 114 may be treated with a water-resistant finish to prevent or reduce water absorption from the outside environment. The outer shell 114 preferably is constructed so as to be flame resistant to protect the wearer against being burned in certain applications. In addition, the outer shell 114 preferably is strong so as to be resistant to tearing and abrasion during use in extreme environments.

When the thermal liner 110, the moisture barrier 112, and the outer shell 114 are integrated, the protective garment 10 may be characterized as having a thermal protective performance (TPP per NFPA 1971) of at least 55 at about 20-25 oz. and a total heat loss of at least 180. It is noted that, although a thermal liner 110 for a firefighter turnout coat is shown in the figure and described herein, the present disclosure pertains to protective garments generally. Accordingly, the identification of firefighter turnout gear is not intended to limit the scope of the disclosure. The thermal liner 110 may be configured for other types of protective garments which include, but are not limited to, suits for industrial workers (including, for example, arc flash apparel), wildland's firefighters, race car drivers, airplane pilots, military personnel, and the like.

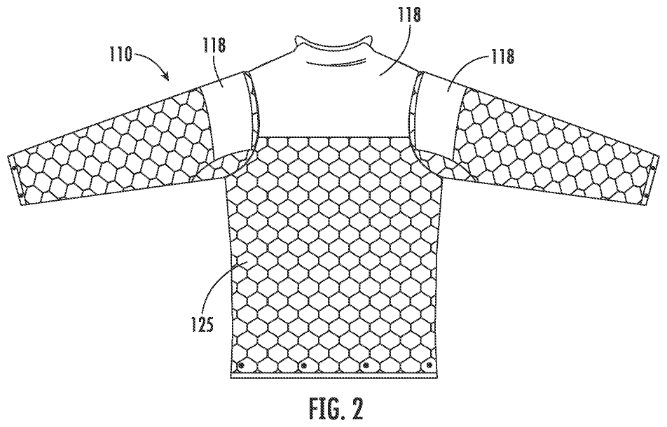

As depicted in FIG. 2, the thermal liner 110 includes one or more augmented portions 118. The augmented portions 118 may be discretely-positioned and used in predetermined areas such as an upper back area, shoulder areas, back of the sleeves, and/or other areas that require additional protection due to exposure to increased temperatures and/or loss of insulating ability caused by compression of the protective garment in those areas. Therefore, the thermal liner 110 may be significantly improved without sacrificing pliability, processibility, and the like.

By using the augmented portions 118, it is possible to eliminate multiple layers of material/fabric used in traditional protective garments, and produce a protective garment 10 that only comprises the thermal liner 110, the moisture barrier 112, and the outer shell 114.

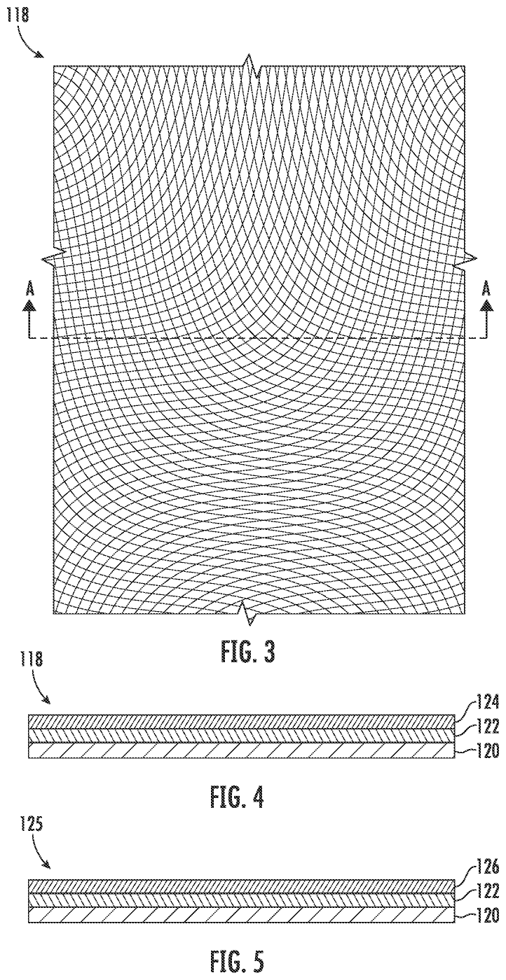

An enlarged view of a surface of the augmented portion 118 is shown in FIG. 3. In certain embodiments, the augmented portion 118 may have a multi-layer construction. As best seen in FIG. 4, the augmented portion 118 may, in some instances, comprises a facecloth layer 120, a first insulation layer 122, and an enhanced thermal layer 124. The layers 120, 122, 124 may be quilted and/or sewn together. It should be appreciated, however, that one of the layers 120, 122, 124 maybe coupled to another one of the layers 120, 122, 124 by any method as desired. In other embodiments, the augmented portion 118 may comprise the facecloth layer 120 coupled to the enhanced thermal layer 124, or the enhanced thermal layer 123 alone. The facecloth layer 120 may be constructed of woven or non-woven material comprising flame resistant and/or moisture-wicking fibers or filaments made of, for example, at least one of aramid (meta-aramid (e.g., Nomex™) or para-aramid (e.g., Kevlar™)), polybenzimidazole, polybenzoxazole, melamine, cellulosics, flame resistant (FR) cellulosics, modacrylic, carbon, or the like, and blends thereof. In one embodiment, the facecloth layer 120 may be produced from at least one of a spunlace, a woven material, a nonwoven material, a stretch woven material, a knit material, a fleece material, and a laminate material, for example. The facecloth layer 120 may be, optionally, finished with a hydrophilic finish that draws perspiration off of the wearer, if desired. In certain embodiments, the facecloth layer 120 may be produced from about 3.3 oz of meta-aramid material.

The first insulation layer 122 may comprise a material that includes one or more flame resistant fibers. The first insulation layer 122 may comprise a single layer of nonwoven material, or two layers of nonwoven material, or multiple layers of nonwoven material. In one embodiment, the insulation layer 122 may be produced from at least one of a spunlace, a woven material, a nonwoven material, a stretch woven material, a knit material, a fleece material, and a laminate material, for example. Preferably, the first insulation layer 122 may be produced from a blend of meta-aramid (e.g., Nomex™) and/or para-aramid (e.g., Kevlar™) spunlace. More preferably, about 2.3 oz. of the spunlace.

In one preferred embodiment, the enhanced thermal layer 124 may be a fleece material produced from a blend of at least one of meta-aramid (e.g., Nomex™) para-aramid (e.g., Kevlar™), and/or anti-static fibers. As a non-limiting example, 7 oz of the fleece material of the enhanced thermal layer 124 may comprise a blend of about 93% of meta-aramid fibers, about 5% of para-aramid fibers, and about 2% of anti-static fibers. It is understood, however, that the present disclosure is not limited to the precise formulations set forth herein.

### Examples:

Results from Total Heat Loss (THL) tests and Thermal Protective Performance (TPP) tests conducted on Specimens 1, 2, and 3 of a protective garment comprising an outer shell produced from polybenzimidazole (e.g., PBI® Max), a moisture barrier including a semipermeable membrane layer (e.g. Stedair® 4000), and a thermal liner produced from a meta-aramid (Nomex®) fleece and a facecloth layer is provided below in Table 1 and Table 2, respectively.

TABLE 1
TOTAL HEAT LOSS TEST NFPA 1971-2018, SECTION 8.33

| | |
|---|---|
| Item Type | Fabric Composites |

| ID | Outer Shell | Moisture Barrier | Thermal Barrier |
|---|---|---|---|
| D | PBI Max | Stedair 4000 | Polartec 7 oz Nomex |
| | | | Fleece on Core CXP 1 |
| | | | Layer Quilted |

| | | DBP | WBP | Rct | Rcf | ARet | ARef | |
|---|---|---|---|---|---|---|---|---|
| | | Avg | Avg | (K · m2/W) | (K · m2/W) | (Pa · m2/W) | (kPa · m2/W) | Qt |
| Conditioning | Specimen | (K · m2/W) | (Pa · m2/W) | (Obs) | (Cal) | (Obs) | (Cal) | (W/m2) |
| As Received | 1 | 0.0754 | 6.1580 | 0.2383 | 0.1629 | 29.6390 | 0.0234 | 182.1 |
| | 2 | 0.0754 | 6.1580 | 0.2370 | 0.1616 | 29.2290 | 0.0231 | 184.0 |
| | 3 | 0.0754 | 6.1580 | 0.2325 | 0.1571 | 29.2580 | 0.0231 | 184.9 |
| | | | | Average | 0.1605 | | 0.0232 | 183.7 |

TABLE 2
SAMPLE ID: D

| | |
|---|---|
| Item Type | Outer Shell: PBI Max |
| | Moisture Barrier: Stedair 4000 |
| | Thermal Barrier: Polartec 7 oz Nomex |
| | Fleece on Core CXP 1 Layer Quilted |

TEST AS RECEIVED ONLY

| | TPP Rating |
|---|---|
| Specimen | As Received |
| 1 | 59.5 |
| 2 | 57.4 |
| 3 | 59.1 |
| Average | 58.7 |

In certain embodiments, a remainder portion 125 of the thermal liner 110, shown in FIG. 5, may be produced from the facecloth layer 120, the first insulation layer 122, and a second insulation layer 126. The second insulation layer 126 may comprise a single layer of nonwoven material, or two layers of nonwoven material, or multiple layers of nonwoven material. In one embodiment, the insulation layer 126 may be produced from at least one of a spunlace, a woven material, a nonwoven material, a stretch woven material, a knit material, a fleece material, and a laminate material, for example. Preferably, the second insulation layer 126 may be produced from a blend of meta-aramid (e.g., Nomex™) and/or para-aramid (e.g., Kevlar™) spunlace. More preferably, about 2.3 oz. of the spunlace.

Advantageously, a protective garment 10 having the thermal liner 110 provides improved comfort (fewer layers) and thermal protection. The thermal liner 110 and the protective garment 10 are compliant with any and all associated NFPA standards.

From the foregoing description, one ordinarily skilled in the art can easily ascertain the essential characteristics of this present disclosure and, without departing from the spirit and scope thereof, can make various changes and modifications to the present disclosure to adapt it to various usages and conditions.

What is claimed is:

1. A portion of a thermal liner, comprising:
a facecloth layer; and
a thermal layer disposed adjacent the facecloth layer, wherein the thermal layer is produced from a fleece material.

2. The portion of the thermal liner of claim 1, wherein the facecloth is produced from at least one of an aramid, a polybenzimidazole, a polybenzoxazole, a melamine, a cellulosic, a flame resistant (FR) cellulosic, a modacrylic, and a carbon material.

3. The portion of the thermal liner of claim 1, further comprising a first insulation layer disposed between the facecloth layer and the thermal layer.

4. The portion of the thermal liner of claim 3, wherein the first insulation layer is produced from at least one of a spunlace, a woven material, a nonwoven material, a stretch woven material, a knit material, a fleece material, and a laminate material.

5. The portion of the thermal liner of claim 1, wherein the fleece material is a blend of at least two different fibers.

6. The portion of the thermal liner of claim 1, wherein the fleece material comprises a blend of at least one of a meta-aramid material, a para-aramid material, and an anti-static material.

7. A protective garment, comprising:
an outer shell; and
a thermal liner disposed adjacent the outer shell, wherein the thermal liner includes at least one augmented portion, the at least one augmented portion comprises a thermal layer produced from a fleece material.

8. The protective garment of claim 7, wherein the at least one augmented portion of the thermal liner is positioned at least one of an elbow area, a back of a sleeve area, a knee area, an upper back area, and a shoulder area of the protective garment.

9. The protective garment of claim 7, wherein the fleece material is produced from at least one of a meta-aramid material, a para-aramid material, and anti-static material.

10. The protective garment of claim 7, wherein the outer shell is produced from at least one of an aramid material, a polybenzamidazole material, a polybenzoxazole material, and an oxidized polyacrylonitrile (OPAN) material.

11. The protective garment of claim 7, wherein the augmented portion of the thermal liner further comprises at least one of a facecloth layer and a first insulation layer.

12. The protective garment of claim 11, wherein the facecloth is produced from at least one of an aramid, a polybenzimidazole, a polybenzoxazole, a melamine, a cellulosic, a flame resistant (FR) cellulosic, a modacrylic, and a carbon material.

13. The protective garment of claim 11, wherein the first insulation layer is produced from at least one of a spunlace, a woven material, a nonwoven material, a stretch woven material, a knit material, a fleece material, and a laminate material.

14. The protective garment of claim 7, wherein a remainder portion of the thermal liner comprises at least one of a facecloth layer, a first insulation layer, and a second insulation layer.

15. The protective garment of claim 14, wherein at least one of the first insulation layer and the second insulation layer is produced from at least one of a spunlace, a woven material, a nonwoven material, a stretch woven material, a knit material, a fleece material, and a laminate material.

16. The protective garment of claim 7, wherein the outer shell is an exterior portion of a firefighter turnout gear.

17. A method of producing a thermal liner, comprising the steps of:
providing a facecloth layer, a first insulation layer, a thermal layer, and a second insulation layer;
arranging the thermal layer together with at least one of the facecloth layer and the first insulation layer to form at least one augmented portion of the thermal liner; and
arranging at least one of the facecloth layer, the first insulation layer, and the second insulation layer together to form a remainder portion of the thermal liner.

18. The method of claim 17, wherein the thermal layer is produced from a fleece material.

19. The method of claim 17, wherein the at least one augmented portion of the thermal liner is positioned at least one of an elbow area, a back of a sleeve area, a knee area, an upper back area, and a shoulder area of a protective garment.

20. The method of claim 17, wherein the thermal liner is configured for a protective garment.
